(19) United States
(12) Patent Application Publication
(10) Pub. No.: US 2017/0031006 A1
(43) Pub. Date: Feb. 2, 2017

(54) RADIO FREQUENCY METAL/CERAMIC BLADE/TOOTH VECTOR ANALYSIS

(71) Applicant: William Thomas Conrad, San Diego, CA (US)

(72) Inventor: William Thomas Conrad, San Diego, CA (US)

(21) Appl. No.: 14/810,206

(22) Filed: Jul. 27, 2015

(51) Int. Cl. G01S 7/41

(52) U.S. Cl. CPC G01S 7/41

(57) ABSTRACT

Briefly, embodiments of the present invention describe an inexpensive, accurate, rapid and automated method to analyze for damage, defects, pitting, material changes, fracture, warpage, chips or contamination in a metal or ceramic turbine blade, pump blade, saw blade, saw tooth, gear tooth or cutting tool. This method utilizes vector signal analysis [also known as a phase-gain meter or automatic network analysis] to observe the phase and amplitude change in the transmitted energy versus the reflected energy in radio waves to detect damage, defects, pitting, material changes, fracture, warpage, chips or contamination in a metal or ceramic turbine blade, pump blade, saw blade, saw tooth, gear tooth or cutting tool. This method describes the means by which to develop specific circuits for the intended application. This method also describes the method by which to develop and tune a specific sensor/circuit for an exact application. This method also describes the type of sensor that would be used with the described method of detection. This method describes the method to obtain the signature of each tooth or blade in a rotating system. This method also describes the application of a sensor employing this method that includes: turbines, turbochargers, saws, pumps, geared equipment or cutting tools.

### FIELD OF THE INVENTION

The present invention is directed to analyze damage, defects, pitting, material changes, fracture, warpage, chips or contamination on a metal or ceramic turbine blade, pump blade, saw blade, saw tooth, gear tooth or cutting tool. The method utilizes the change in phase and or amplitude of the Radio Frequency transmitted energy versus the reflected energy using vector network analysis to form a signature as the object of interest passes in front of one (or more) antenna(s) or a coil of wire. This method may be used in turbines, turbochargers, saws, pumps, geared equipment or cutting tools.

### BACKGROUND OF THE INVENTION

At present, damage, defects, pitting, material changes, fracture, warpage, chips or contamination may be present on a metal or ceramic turbine blade, pump blade, saw blade, saw tooth, gear tooth or cutting tool. This can occur at the time of manufacturing, a sudden event or during a normal course of operation. A common example would be a foreign object that is introduced into a turbine that would cause a turbine blade to become damaged. In some cases it is necessary or advantageous to detect this condition. For example, a damaged turbine blade could unbalance an engine or cause inefficient operations and lead to a major failure. This condition could have serious effects on a system, process or person.

There are presently several methods for analyzing metal or ceramic turbine blades, pump blades, saw blades, saw tooth, gear tooth or cutting tools. These include manual optical inspection where a person [or computer vision] looks for damage, defects, pitting, material changes, fracture, warpage, chips or contamination. Another is to use sound energy [ultrasonic] to detect the presence of damage, defects, pitting, material changes, fracture, warpage, chips or contamination. The ultrasonic method works by measuring the resonant frequency or the ultrasonic echo within the blade. Some ultrasonic methods also use the Doppler Effect for detection. Another method is mechanically measure the outside of a metal or ceramic turbine blade, pump blade, saw blade, saw tooth, gear tooth or cutting tool to see that it is up to mechanical specifications. Another method is to use an acoustic sensor during operation to sense when an acoustic change (vibration) is present.

While these present methods work, they have flaws. The optical methods suffer from requiring cleaning to ensure that the sensor is not detecting dirty optics. This method also requires a delicate sensor (camera) to be present at the sense point. This method may require disassembly to view the blade. The ultrasonic method also requires a sensor to inspect each blade and generally does not work while the blade is in operation. The acoustic method does not always give repeatable results and requires extensive modeling/testing.

What is needed is an inexpensive, accurate, rapid and automated method to analyze for damage, defects, pitting, material changes, fracture, warpage, chips or contamination in a metal or ceramic turbine blade, pump blade, saw blade, saw tooth, gear tooth or cutting tool. This patent describes how observing the phase and amplitude change of the Radio Frequency transmitted energy versus the reflected energy using vector network analysis in a metal or ceramic turbine blade, pump blade, saw blade, saw tooth, gear tooth or cutting tool will show the presence of damage, defects, pitting, material changes, fracture, warpage, chips or contamination. This method could be used in sensors for turbines, turbochargers, saws, pumps, geared equipment or cutting tools.

### PATENT CITATIONS

U.S. Pat. No. 7,428,842
U.S. Pat. No. 7,841,237
U.S. Pat. No. 8,558,538
U.S. 29533183
U.S. 20020088282
U.S. 20130311156

### SUMMARY OF THE INVENTION

Briefly, embodiments of the present invention describe an inexpensive, accurate, rapid and automated method to analyze for damage, defects, pitting, material changes, fracture, warpage, chips or contamination in a metal or ceramic turbine blade, pump blade, saw blade, saw tooth, gear tooth or cutting tool. This method utilizes vector signal analysis [also known as a phase-gain meter or automatic network analysis] to observe the phase and amplitude change in the transmitted energy versus the reflected energy in radio waves to detect damage, defects, pitting, material changes, fracture, warpage, chips or contamination in a metal or ceramic turbine blade, pump blade, saw blade, saw tooth, gear tooth or cutting tool. This method describes the means by which to develop specific circuits for the intended application. This method also describes the method by which to develop and tune a specific sensor/circuit for an exact application. This method also describes the type of sensor that would be used with the described method of detection. This method describes the method to obtain the signature of each tooth or blade in a rotating system. This method also describes the application of a sensor employing this method that includes: turbines, turbochargers, saws, pumps, geared equipment or cutting tools.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout different views. Others will be readily apparent to those skilled in the art.

FIG. 1 Phase Relationship;

FIG. 2 Block Diagram of Single Port RF Vector Network Analyzer Circuit;

FIG. 3 Block Diagram of Direct Single Port RF Vector Network Analyzer Circuit;

FIG. 4 Block Diagram of 2 Port RF Vector Network Analyzer Circuit;

FIG. 5 Block Diagram of Direct 2 Port RF Vector Network Analyzer Circuit;

FIG. 6 Block Diagram of Single Port RF Vector Network Analyzer Circuit to Coil;

FIG. 7 Block Diagram of Direct Single Port RF Vector Network Analyzer Circuit to Coil;

FIG. 8 Block Diagram of Simplified RF Phase Detection Circuit;

FIG. 9 Block Diagram of Simplified 74HCT9046 RF Phase Detection Circuit;

FIG. 10 Diagram of Sensor Location;

FIG. 11 Diagram of Antenna Sensor Output.

### DETAILED DESCRIPTION OF THE INVENTION

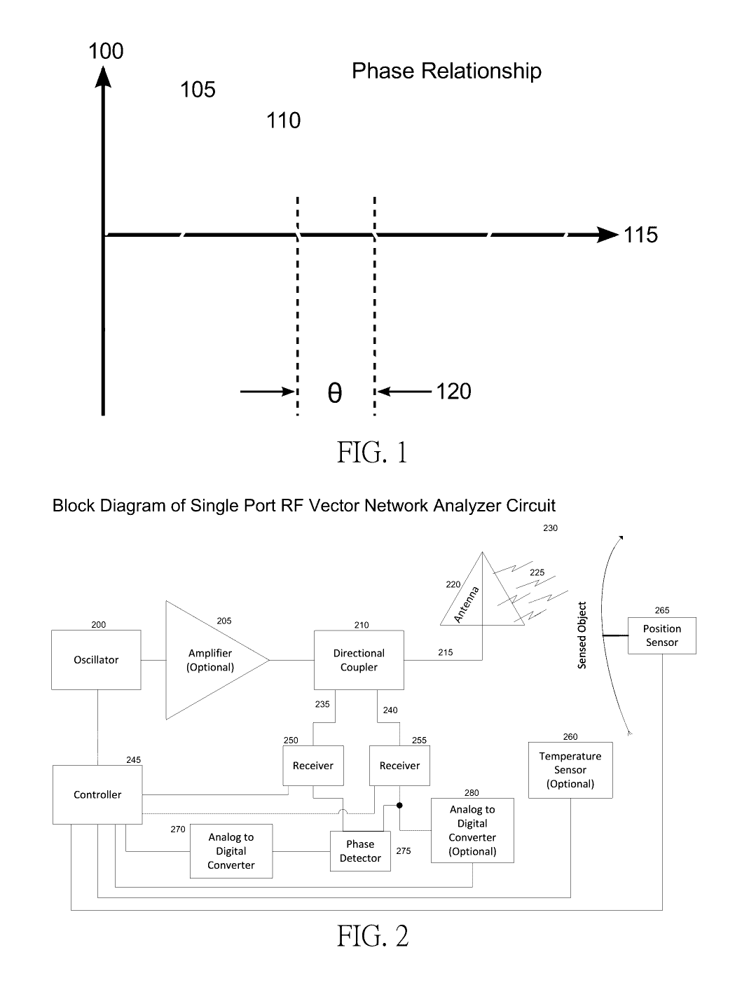

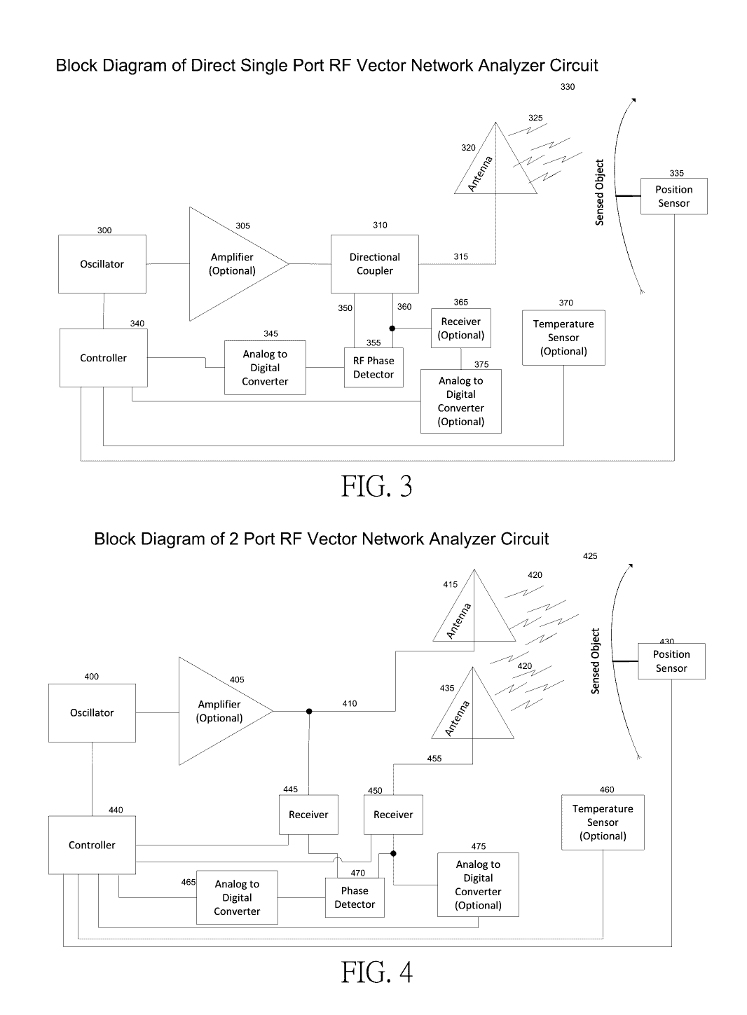

This patent describes an inexpensive, accurate and automated method to analyze for damage, defects, pitting, material changes, fracture, warpage, chips or contamination in a metal or ceramic turbine blade, pump blade, saw blade, saw tooth, gear tooth or cutting tool. This method uses vector network phase and amplitude change in the transmitted energy versus the reflected energy in radio waves when damage, defects, pitting, material changes, fracture, warpage, chips or contamination changes are present in a metal or ceramic turbine blade, pump blade, saw blade, saw tooth, gear tooth or cutting tool. When a normal [without damage, defects, pitting, material changes, fracture, warpage, chips or contamination] metal or ceramic turbine blade, pump blade, saw blade, saw tooth, gear tooth or cutting tool is present of the sense antenna [or coil of wire], there may be slight changes in the amplitude of the returned signal but generally little change in phase will be observed. When damage, defects, pitting, material changes, fracture, warpage, chips or contamination are passed in front of the antenna [or coil of wire], there may be changes in the amplitude of the returned signal but a pronounced change in phase will be observed at certain frequencies. This change in phase correlates to the presence of damage, defects, pitting, material changes, fracture, warpage, chips or contamination. A vector network analyzer also known as a phase-gain meter or automatic network analyzer looks specifically at the amplitude and phase change between one or more signals at one or many radio frequencies. This method may employ SWR (Standing Wave Ratio) which is the ratio of the amplitude of a partial standing wave at an antinode (maximum) to the amplitude at an adjacent node (minimum), in an electrical transmission line or in this case the antenna or coil of wire next to the area of where the sample [eg turbine blade] is being detected. The SWR is usually defined as a voltage ratio called the VSWR, for voltage standing wave ratio. For example, the VSWR value 1.2:1 denotes a maximum standing wave amplitude that is 1.2 times greater than the minimum standing wave value. It is also possible to define the SWR in terms of current, resulting in the ISWR, which has the same numerical value. [Note: this method of damage, defects, pitting, material changes, fracture, warpage, chips or contamination is compatible with measuring the phase in the transmitted versus reflected current.] SWR is used as an efficiency measure for transmission lines, electrical cables that conduct radio frequency signals, used for purposes such as connecting radio transmitters and receivers with their antennas, and distributing cable television signals. SWR measures the relative size of these reflections. An ideal transmission line would have an SWR of 1:1, with all the power reaching the destination and none of the power reflected back. An infinite SWR represents complete reflection, with all the power reflected back down the cable. In this method, what is observed in the difference in the phase between the transmitted energy and the reflected energy. Phase or phase difference is the difference, expressed in electrical degrees or time, between two waves having the same frequency and referenced to the same point in time. Two oscillators that have the same frequency and no phase difference are said to be in phase. Two oscillators that have the same frequency and different phases have a phase difference, and the oscillators are said to be out of phase with each other. The amount by which such oscillators are out of phase with each other can be expressed in degrees, 0°-360°, +/−180°, radians, 0-2π, 0-1 volt, 0-100%, 0-100 uS or 0-256 bits. For this method the unit(s) of phase measurement are not important; only that there is a measurable difference in the phase of the transmitted energy versus the reflected energy. Referring now to FIG. 1, we can see a plot of the phase of two signals. The amplitude of the signal is shown in (100) as the Y or vertical plot. This amplitude is measured in volts [or dB] representing the intensity of the transmitted energy and the reflected energy. This amplitude could also be in current or wattage. The transmitted signal is shown in (105). This is shown in this example figure as a sine wave but the actual signal could be any waveform. The reflected [in this diagram represented as out of phase] energy is shown in (110). In this diagram the reflected signal is shown with less amplitude a sine wave. The actual reflected signal may not be the same wave shape or intensity as the transmitted signal. The time axis of this diagram (this is related to frequency) is shown in (115) as the X or horizontal plot. The units of time are fractions of a second and change as the frequency changes. One would do testing to determine the best frequency to show the largest shift in phase and/or amplitude in the presence of the detected property. The difference in phase is shown in (120). Note that in the diagram, the phase is being measured at the zero crossing point however it could be measured at any point on the waveform such as the high or low point. This phase is the measured difference between the transmitted energy (105) and the reflected energy (110). This difference is known as the phase. There are many methods of making a single port radio frequency network vector [change of phase or amplitude] circuit for this method. The main items in a vector network analyzer circuit are an oscillator, amplifier (if the inherent signal strength of the oscillator is sufficient, this can be eliminated), a directional coupler, a receiver, controller and a circuit to measure the phase. Referring now to FIG. 2, an oscillator is used to generate the RF frequency (200). In general the oscillated signal does not need to be complex for this method. A simple sine wave or sweeping sine wave will work well. However for more precise analysis of damage, defects, pitting, material changes, fracture, warpage, chips or contamination on a metal or ceramic turbine blade, pump blade, saw blade, saw tooth, gear tooth or cutting tool, a different waveform may be used that is better suited for the testing environment or detected objects. There are many different types of oscillators including an Armstrong (or Tickler or Meissner), Astable multivibrator, blocking, Butler, clapp, Colpitts, Delay line, dow (or ultra-audion), Hartley, Pierce, relaxation, RLC circuit, Royer, Va\check{c}ká\check{r}, Wien bridge, voltage controlled oscillator (VCO), sweep, synthesized [using an digital to analog converter controlled by an FPGA, (also known as CPLD, PLD, PAL) microprocessor, microcontroller, ASIC, DSP, or ROM] or crystal oscillator. For this application the sweep or Voltage Controlled Oscillator is ideal. The frequency of the oscillator depends on the types of parent material [eg turbine blade] and the type damage, defects, pitting, material changes, fracture, warpage, chips or contamination. After the oscillator is an optional RF amplifier (205). This application normally uses a low amount of Radio Frequency energy but in the event that this energy or signal level is not enough for the application, an RF amplifier may be used to boost the signal. After the amplifier, the signal is passed through a directional coupler (210). The directional coupler is a passive device gives a representation of the transmitted energy (235) and the reflected energy (240). Directional couplers are most frequently constructed from two coupled transmission lines set close enough together such that energy passing through one is coupled to the other. This technique is favored at the microwave frequencies. However, lumped component devices are also possible at lower frequencies. At microwave frequencies, particularly the higher bands, waveguide directional couplers can be used. Many of these waveguide couplers correspond to one of the conducting transmission line designs, but there are also types of directional couplers that are unique to waveguide. There are many types of directional coupler depending on the frequency, precision and amount of power. This includes: Coupled transmission lines, branch-line coupler, Wilkinson power divider, hybrid ring coupler, waveguide branch-line coupler, Bethe-hole directional coupler, Riblet short-slot coupler, Schwinger reversed-phase coupler, 90° hybrid coupler or a Moreno crossed-guide coupler. A simple directional coupler can be made with a resistor to provide a higher impedance source separated from a low impedance source. The signal then passes through wire, coax cable or waveguide (215). The signal then passes to an antenna (220) that emits radio waves (225) in the presence of the sensed object (230) [for example a turbine blade]. The reflected radio waves (225) are then sent back into the antenna (220). It is important to note that if the sensed object is metal that the RF circuit should share a common ground with the sensed object. If the sensed object is nonconductive such as ceramic, there should be a ground plane near the antenna for proper impedance matching. The antenna (220) size and type depends on the size of the area to be measured [eg. turbine blade] and the damage, defects, pitting, material changes, fracture, warpage, chips or contamination that are desired to be analyzed. An example antenna would be a small conductive flat plate of 1 cm by 4 cm. It is ideal to have minimal space between the antennas and the sensed object. There should be an insulating material between the antenna and the turbine blade, pump blade, saw blade, saw tooth, gear tooth or cutting tool housing if the housing is made out of a conductive material. As damage, defects, pitting, material changes, fracture, warpage, chips or contamination in a metal or ceramic turbine blade, pump blade, saw blade, saw tooth, gear tooth or cutting tool pass in front of the antenna, the phase and/or amplitude of the radio waves will change in the transmitted energy compared to the reflected energy. The theory behind this is that a change in the environment in front of the antenna will cause a change in impedance and this causes a pronounced affect in the phase and amplitude domain. Every material has an electric permittivity and this is related by the Greek character epsilon (c). Epsilon affects and is affected by a dielectric medium. More electric flux exists in a medium with a high permeability (unit per charge) because of polarization effects. Permittivity relates to the material to transmit or permit an electric field. A damage, defects, pitting, material changes, fracture, warpage, chips or contamination will have a different permeability over a normal blade. This change of phase will be present in the signal output of the directional coupler (240). The transmitted energy (235) will be sent to a receiver (250) to demodulate the signal. The receiver takes the RF frequency and converts it to a signal compatible with the phase detector. Some phase detectors can work at the RF frequency and eliminate the need for receivers as described in FIG. 3. Some receiver may have an amplifier stage before the receiver to boost the signal to the receiver for better sensitivity. There are several types of receivers including: AM, heterodyne, superheterodyne, phase locked loop, digital (using an analog to digital converter that sends the digital information to a microprocessor/FPGA/ASIC), Gunn diode, crystal, neutrodyne, regenerative or direct conversion. The reflected energy (240) from the directional coupler (210) is also sent through a receiver (255). The receivers and oscillator are controlled by an analog circuit or controller (245). The function of the controller is to select one or many frequencies of interest by controlling the oscillator, controlling the frequency of each receiver and analyzing the phase relationship, relating the waveforms to the position of the tooth or blade and optionally analyzing the amplitude waveform, optionally correlating the temperature of the sample area. The signal may be swept through these frequencies slowly or rapidly depending on the application. The controller may be a simple type that fixes the oscillator and receivers to a single value or a complex type with multiple frequencies and different transmitted waveforms. The signals out of the receivers are sent to a phase detector (275) and the output of the phase detector represents the presence (or non-presence) of damage, defects, pitting, material changes, fracture, warpage, chips or contamination. Obtaining the phase difference with analog circuits involves computing the arcsine and arccosine of each normalized input (to get an ever increasing phase) and then doing a subtraction. One type of analog phase detector is a quadrature phase detector that can be made by summing the outputs of two multipliers. The quadrature signals may be formed with phase shift networks. Two common implementations for multipliers are the double balanced diode mixer (diode ring) and the four-quadrant multiplier (Gilbert cell). Another method is to use a mixer-based detector (e.g., a Schottky diode-based double-balanced mixer). Both the quadrature and simple multiplier phase detectors have an output that depends on the input amplitudes as well as the phase difference. In practice, the input amplitudes are normalized. There are also analog integrated circuits that perform phase detection such as the Analog Devices AD8302. A digital phase detector may be made by using a square wave [the demodulated signal after the receiver] exclusive-OR (XOR) logic gate. When the two signals being compared are completely in-phase, the XOR gate's output will have a constant level of zero. When the two signals differ in phase by 1°, the XOR gate's output will be high for 1/180th of each cycle, the fraction of a cycle during which the two signals differ in value. When the signals differ by 180°; that is, one signal is high when the other is low, and vice versa. The XOR gate's output remains high throughout each cycle. The XOR detector compares well to the analog mixer in that it locks near a 90° phase difference and has a square-wave output at twice the reference frequency. The square-wave changes duty-cycle in proportion to the phase difference resulting. Applying the XOR gate's output to a low-pass filter results in an analog voltage that is proportional to the phase difference between the two signals. It requires inputs that are symmetrical square waves, or nearly so. The remainder of its characteristics are very similar to the analog mixer for capture range, lock time, reference spurious and low-pass filter requirements. Digital phase detectors can also be based on a sample and hold circuit, a charge pump, or a logic circuit consisting of flip-flops. When a phase detector that's based on logic gates is used in a Phase Locked Loop (PLL), it can quickly force the VCO to synchronize with an input signal, even when the frequency of the input signal differs substantially from the initial frequency of the VCO. Such phase detectors also have other desirable properties, such as better accuracy when there are only small phase differences between the two signals being compared. The controller takes the phase information and combines it with position that is obtained with a position sensor (265). The position is a resolver, encoder, LVDT, RVDT, synchro or top dead center indicator. A top dead center indicator would use a timer in the controller to compute position based on the blade/tooth Revolutions Per Minute (RPM.) The controller builds a signature of phase and amplitude versus position of the sensed blade or tooth. The controller keeps track of changes in RPM to correct for the Doppler Effect that will change the signature. An optional output of the controller is the exact RPM of the turbines, turbochargers, saws, pumps, geared equipment or cutting tool. The amplitude is obtained with an optional receiver output that is sent to an analog to digital converter (280). The amplitude waveform contains different information about the sample (EG turbine blade) than the phase and can be useful for obtaining different properties. In addition temperature can be measured to further refine the measurement with an optional temperature sensor (260). As the temperature changes in the density and other properties of the sensed material property will change. With some experimentation the change of phase and frequency of interest can be identified and correlated to temperature. This information can then be applied to adjust the algorithm detection parameters to further improve accuracy and could also be used to adjust frequency, signal strength and waveform shape. The controller can used an algorithm to do filtering, normalizing and precise analysis. The controller can use high and low limits to analyze the signature to determine the presence of damage, defects, pitting, material changes, fracture, warpage, chips or contamination.

Another method to analyze damage, defects, pitting, material changes, fracture, warpage, chips or contamination is to use a direct single port radio frequency network vector. Referring now to FIG. 3, like the (200) method, a controller (340) sends a signal to an oscillator is used to generate the RF frequency (300), and this passes through an optional RF amplifier (305) to a directional coupler (310), to coax cable or wire (315) and to an antenna (320). The antenna radiates radio energy (325) through the sensed object (330). The difference between method (200) and this is the transmitted energy (350) and the received energy (360) is sent directly to a RF phase detector (355). The advantage of this method is that the receiver(s) may be eliminated. The phase detector must be sensitive enough to be able to operate at the levels that the oscillator and optional amplifier are operating at. If this is not the case, an amplifier may be used to boost the signal into the RF phase detector. The output of the phase detector (355) is sent to an analog to digital converter (345) to the controller (340). This method also has a position sensor (335) to give the controller the blade position to make the signature of each blade/tooth, optional temperature sensor (370), optional receiver for measuring amplitude (365) and option analog to digital converter (375) to send the amplitude signal to the controller (340).

Another method to analyze damage, defects, pitting, material changes, fracture, warpage, chips or contamination is to use a two port radio frequency network vector analyzer. This circuit is nearly identical to a single port circuit except that there is no directional coupler. The advantage of this circuit is better coupling which leads to more sensitive detection. This method also may have advantages for sensing nonconductive blades. Referring now to FIG. 4, an oscillator is used to generate the RF frequency (400) then to an optional RF amplifier (405). The signal then passes to a transmitting cable (410), antenna (415) that emits radio waves (420) in the presence of the sensed object (425) (eg turbine blade), then received by the receiving antenna (435) and receiving cable (455). The transmitted energy will be sent to a receiver (445) to demodulate the signal. The received energy will be sent to a receiver (450) to demodulate the signal. The receiver takes the transmitted and received energy and converts it to a signal compatible with the phase detector (470) and then to an analog to digital converter (465). The receivers and oscillator are controlled by a controller (440). This method also has a position sensor (430) to give the controller the blade position to make the signature of each blade/tooth, optional temperature sensor (460) and optional analog to digital converter (475) for measuring amplitude. Note that this description had a single receiving antenna. Additional antenna could be added to capture different properties of the sensed object.

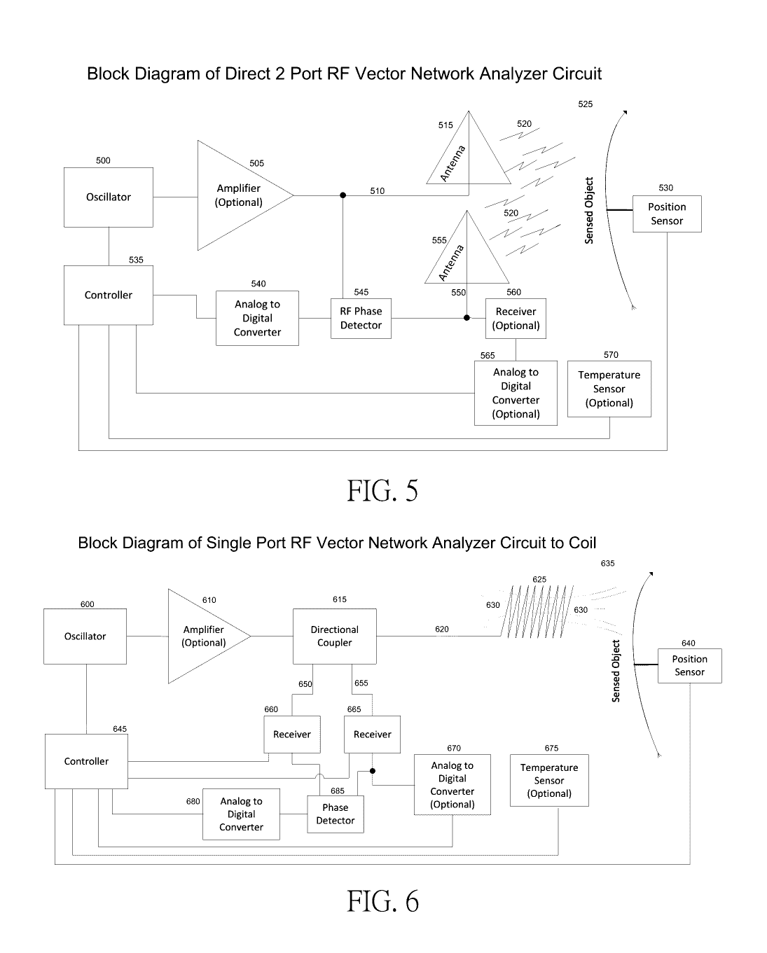

Another method to analyze damage, defects, pitting, material changes, fracture, warpage, chips or contamination is to use a direct two port radio frequency network vector analyzer. This circuit is nearly identical to a two port circuit (400) except that there is no receiver before the phase detector. The advantage of this circuit is the elimination of the receiver. Referring now to FIG. 5, an oscillator is used to generate the RF frequency (500). After the oscillator is an optional RF amplifier (505). The signal then passes to a transmitter cable (510) an antenna (515) that emits radio waves (520) in the presence of the sensed object (525), then received by the receiving antenna (555) and the receiving cable (550). Radio waves will pass through the sensed object from the antenna to the receiving antenna. The transmitted energy (510) and the received energy (550) are sent to a RF phase detector (545) and the output of the phase detector is sent to an analog to digital converter (540) then to the controller (535). The phase detector must be sensitive enough to be able to operate at the levels that the oscillator and optional amplifier are operating at. If this is not the case, an amplifier may be used to boost the signal into the RF phase detector. This method also has a position sensor (530) to give the controller the blade position to make the signature of each blade/tooth, optional temperature sensor (570) and optional receiver (560) analog to digital converter (565) for measuring amplitude. Note that this description had a single receiving antenna. Additional antenna could be added to capture different properties of the sensed object.

Another method to analyze damage, defects, pitting, material changes, fracture, warpage, chips or contamination is to use a single port radio frequency network vector analyzer that is connected to a coil as opposed to an antenna. The advantage of this method is that it operates at a lower frequency and this may use lower cost parts. The method described in FIGS. 2 through 5 relies on the electrical properties of the material through the use of an antenna while this method relies on the magnetic properties of the material through the use of a coil. The theory behind this is that a change in the environment (eg turbine blade) within the magnetic presence of the coil of wire will cause a change in impedance and this causes a pronounced affect in the phase domain. Every material has magnetic permittivity and this is represented by the Greek character μ. The permeability constant (μ), also known as the magnetic constant or the permeability of free space, is a measure of the amount of resistance encountered when forming a magnetic field. A closely related property of materials is magnetic susceptibility, which is a measure of the magnetization of a material in addition to the magnetization of the space occupied by the material. This coil of wire sensor is known as a B field sensor. Referring now to FIG. 6, a controller (645) sends a signal to an oscillator is used to generate the RF frequency (600), and this passes through an optional RF amplifier (610) to a directional coupler (615), to a wire, coax cable (620) and to a coil of wire (625) that generates a magnetic field (630). The magnetic field interacts with the sensed object (635). Note that the coil of wire should be insulated from the sensed object housing and sensed object. The transmitted energy (650) and the received energy (665) go to a receiver (660) (665) and then to a phase detector (685). The output of the phase detector goes to an analog to digital converter (680) then to the controller (645). This method also has a position sensor (640) to give the controller the blade position to make the signature of each blade/tooth, optional temperature sensor (675) and optional analog to digital converter (670) for measuring amplitude.

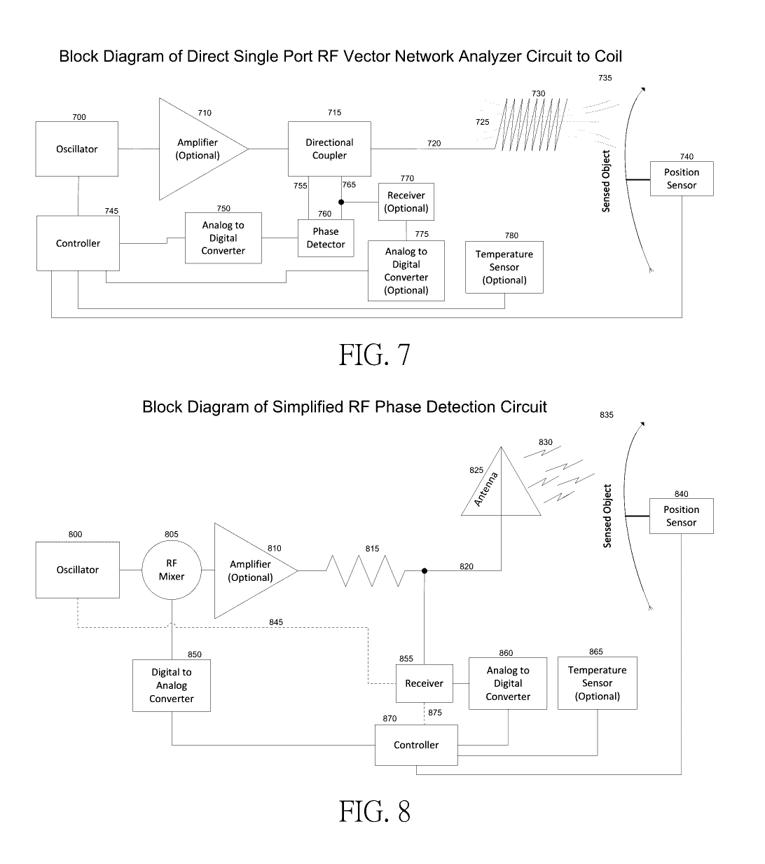

Another method to analyze damage, defects, pitting, material changes, fracture, warpage, chips or contamination is to use a direct single port radio frequency network vector analyzer that is connected to a coil as opposed to an antenna with no receiver. The advantage of this method is the elimination of the receiver. Referring now to FIG. 7, like the (600) method, a controller (745) sends a signal to an oscillator is used to generate the RF frequency (700), and this passes through an optional RF amplifier (710) to a directional coupler (715) to a wire or coax (720) and to a coil of wire (730), that generates a magnetic field (725). The coil of wire is near the sensed object (735) (eg turbine blade). The transmitted energy (755) and the received energy (765) go to a RF phase detector (760). The output of the phase detector would go to an analog to digital converter (750) and then to the controller (745) and represent the phase. This method also has a position sensor (740) to give the controller the blade position to make the signature of each blade/tooth, optional temperature sensor (780), optional receiver (770) and optional analog to digital converter (775) for measuring amplitude.

Another method to analyze damage, defects, pitting, material changes, fracture, warpage, chips or contamination is to use a dedicated single port radio frequency network vector analyzer detection circuit. The advantage of this method is that the receiver for the transmitted energy can be eliminated from the design. This is because the controller has direct control over the modulated signal and the output from the controller would represent the modulated transmitted energy exactly. The modulated waveform may be a sine, swept sine, square or other waveform that is either a fixed frequency or swept through a range of frequencies. Referring now to FIG. 8, an oscillator generates a fixed frequency (800), a controller (870) generates a digital waveform that is sent to the digital to analog converter (850). The output of the digital to analog converter is sent to an RF mixer (805). An RF mixer adds the signal on top of the oscillated signal to generate a modulated RF signal. [Note that the controller could connect directly to the mixed without the digital to analog converter by making a square wave output]. After the mixer is an option RF amplifier. (810) the amplifier is used if the signal is insufficient signal strength after the RF mixer. This signal is then passed through a directional coupler [in this case a resistor but other directional couplers would work] (815) that allow a limited current to pass through, proportional to the load that is placed on its output. The signal then passes from the directional coupler to a cable (820) and then to an antenna (825) that emits radio waves (830) in the presence of the sensed object (835). The reflected energy is sent to a receiver (855) and then the output of the receiver is sent to an analog to digital converter (860). Note that the receiver may have an input amplifier to improve the signal strength. Alternatively, the receiver output signal could go directly to the controller's digital input (875). This would not be as accurate but reduce the cost of the circuit. The receiver converts the RF frequency which is modulated by the voltage controlled oscillator makes and a manageable low frequency signal for the analog to digital converter. An optional more stable receiver could be locked to the oscillator for a more accuracy (845). The analog to digital converter (860) takes the demodulated signal and converts it to a digital stream of data that is sent to the controller (870). This digital stream is then processed by the controller using an algorithm. A typical algorithm starts by filtering the initial signal with a low pass or filter to remove noise. However if the design is stable enough, this step may be eliminated. The algorithm would then compare the entire signal a measure the average DC offset and remove this with an addition or subtraction. However if the design is stable enough, this step may be eliminated. The algorithm would then take the average peak values and apply a multiplication to make the signal uniform. However if the design is stable enough, this step may be eliminated. The algorithm would then do a phase comparison of the signal that the algorithm generated [this is represented by the output of the analog to digital converter (850)] and the reflected signal looking at both zero crossing points or the positive/negative peaks. There would be some calibration done in advance to adjust for the time [delay] that is required for the length of wire to the antenna, processing, analog to digital, digital to analog, voltage controlled oscillator and the receiver. This time would be subtracted from the phase measurement to give a corrected phase. Additional averaging could also be applied to further improve accuracy and reduce false signals. When the this algorithm looks at the phase and amplitude signature detects a change of phase this would indicate damage, defects, pitting, material changes, fracture, warpage, chips or contamination. The algorithm can be set for a fast change in phase and ignore a slow change in phase or vice versa. In addition the algorithm could use temperature to further refine detection accuracy. This method could utilize an optional temperature sensor (865). This method also has a position sensor (840) to give the controller the blade position to make the signature of each blade/tooth.

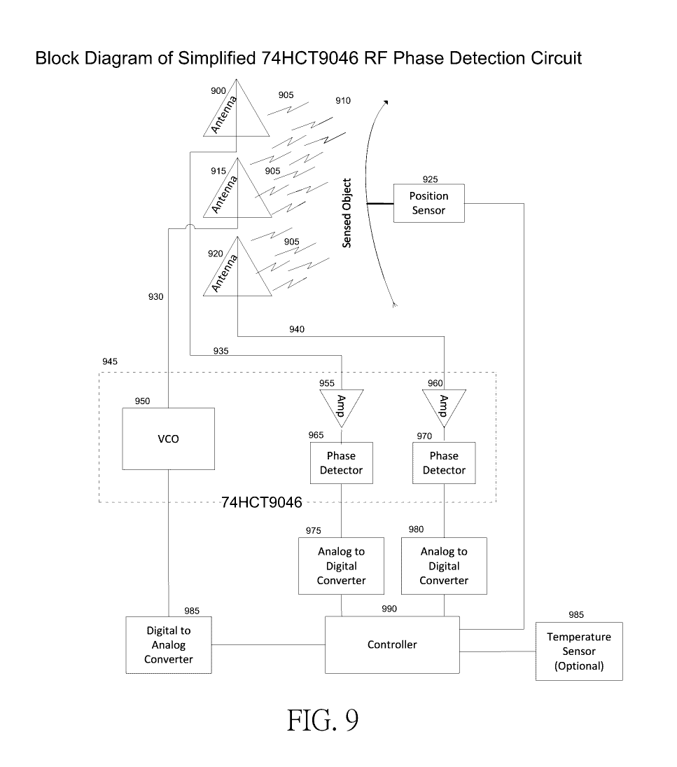

Another method to analyze damage, defects, pitting, material changes, fracture, warpage, chips or contamination is to use a simplified version of a dual/triple port radio frequency network vector network phase detection circuit with a 74HCT9046 (or similar integrated circuit.) Referring now to FIG. 9, a Phase Locked Loop (PLL) with band gap controlled VCO integrated circuit [74HCT9046] (945) is set up to analyze damage, defects, pitting, material changes, fracture, warpage, chips or contamination. The controller (990) would be set a fixed or sweep frequency and observe the phase difference. The 74HCT9046 (945) has two phase detector circuits. This allows for three different configurations. The first is to have one transmitter and one receiver antenna observing a sample area that will analyze damage, defects, pitting, material changes, fracture, warpage, chips or contamination and this would be used as a control to show the amount of phase offset generated by the environment. The second configuration would be to observe the sample area with one transmitter and two receiver antennas in the same orientation. If the controller observed a signal from one sensor but not the other, this could be a false positive and the controller could eliminate this false positive. If the change of phase was detected in both phase detectors then the controller would have a confident result. This third is to have a one transmitter and two receiver antennas with the second receiving antenna in a different antenna configuration to look for different properties in the sensor area. The second antenna might be a different type of be located in a different orientation. The controller (990) first sends a digital signal to the digital to analog converter (985) and this generates a voltage that controls the voltage controlled oscillator (950) within the 74HCT9046 (945). The VCO (950) generates an

RF output that is sent to a transmitting cable (930) antenna (915). The RF energy (905) from the transmitting cable (930) passes through the sample area (910) and then to either one or both receiving antenna's (900), (920). The output of the first antenna (900) is sent to a receiving cable (935) then is sent to and amplifier (955) inside the 74HCT9046 and this is sent to a phase detector (965) inside the 74HCT9046 which compares the phase of the VCO (950) to the received signal. The output of the phase detector (965) is sent to and A-D (875) and this is sent to the controller (990). The phase detector compares the phase of the input signal to the internal VCO of the 74HCT9046. If a second antenna is used (920), it's signal would be sent to a receiving cable (940) an amplifier (960), then to a phase detector (970), then an A-D (980) and then into the controller (990). This method also has a position sensor (925) to give the controller the blade position to make the signature of each blade/tooth and optional temperature sensor (985).

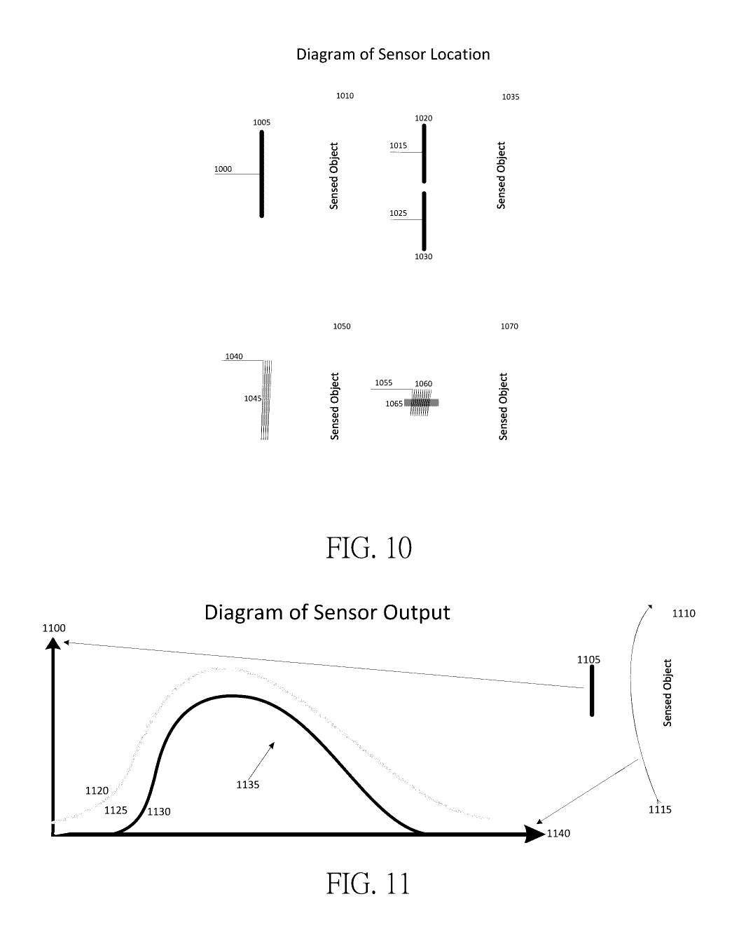

The this method utilizes an antenna or coil sensor to analyze for damage, defects, pitting, material changes, fracture, warpage, chips or contamination depends on the specific application. Referring now to FIG. 10, are 4 examples of sensors and their locations. For a single port analysis, the sensor antenna (1005) would be connected to the circuit with a wire, coax cable or waveguide (1000). The sensed object (1010) would be physically near the sensor (1005). The location would depend on the type of damage, defects, pitting, material changes, fracture, warpage, chips or contamination that is being looked for and some experimentation would be required to obtain the optimal location. Ideally the sensor would be perpendicular to the blade or tooth but it could be parallel or at an angle. The sensing antenna would have to be isolated from the metal housing that contains the blade. The ideal insulating material is Teflon but other nonconductive substances would also work. The sense antenna size and configuration would depend on the blade and the specific property that is being analyzed. A typical antenna would be a copper strip 1 cm by 4 cm insulated from the housing with Teflon or ceramic material. In a two port configuration the antennas (1020) and (1030) would be connected to a circuit using a wire, coax cable or waveguide (1015) and (1025). The location of the antenna and the sensed object (1035) would depend on the blade and the specific property that is being analyzed. The two antennas may be above and below each other or side by side. Some experimentation would be needed to optimize performance for the specific property that is being analyzed. Another configuration would be to use a coil of wire. The sensed object (1050) would have a coil of wire (1045) that is connected to the circuit with a wire or coax cable (1040). The diameter of the coil, type of wire used in the coil and location would depend on the blade/tooth and the specific property that is being analyzed. The best results would be if the coil was as close as possible to the blade. Another configuration would be to use a ferrite core to concentrate the magnetic field. This configuration would have a different electrical properties over the coil of wire without the ferrite core. The sensed object (1070) would have a coil of wire (1060) that is connected to the circuit with a wire or coax cable (1055). The wire would be wrapped around a ferrite core (1065) to concentrate the magnetic field. The diameter of the coil, type of wire and ferrite used in the coil and location would depend on the blade and the specific property that is being analyzed.

The signature of an individual blade is made up by sampling several phase/amplitude measurements over time (while the blade passes the sensor antenna). Referring now to FIG. 11, a blade/tooth (1110) passes in front of a sensor (1105) as it does so, its position is measured (1115) with a position sensor. Note that there may be multiple antenna/coil sensors. The vector network circuit sensor is continuously measuring phase and optionally amplitude of the transmitted and received signal in the sensor (1105). The output of these measurements is intensity (signal strength and is represented on the as the Y or vertical plot (1100). The units for this are measured in either volts or decibels. This measurement could also be made in current or wattage but voltage utilizes the least amount of circuitry. The position correlated by the position sensor is represented on the X or horizontal plot (1140). The units for this X axis could be 0°-360°, +/−180°, degrees, radians, 0-2π, 0-1 volt, 0-100%, 0-100 uS, 0-100 mm, 0-3 inch or 0-256 bits. For this method the unit(s) of position measurement are not important; only that there is a measurable difference and that the controller knows exactly what the individual blade/tooth position is. As the blade of the sensed object passes in front of the sensor an output waveform is made by the controller sampling several times and having the controller recording the position of each sample. The greater the number of samples, the more precise the signature will be. The result of this is a signature of each blade (1125). Each individual blade will have a unique signal due to different metallurgy or material make up. As the blade/tooth changes due to damage, defects, pitting, material changes, fracture, warpage, chips or contamination the signature will change. One can set an upper limit (1120) and lower limit (1130) to automatically analyze the signature. In this figure the signature has an out of lower range condition (1135) that may indicate damage, defects, pitting, material changes, fracture, warpage, chips or contamination. These limits could be adjusted to compensate for temperature and RPM variations for greater precision.

In order to determine what frequency and how much phase/amplitude shift will occur during the analysis for damage, defects, pitting, material changes, fracture, warpage, chips or contamination, some experimentation is required. This can be accomplished in two ways. The first is to use an instrument that operates over a wide frequency range and the second is to build one or many circuits over a specific range to measure the amplitude and/or phase. The instrument of choice for the first method is a single port, dual port or multiport port vector network analyzer such as the Rohde & Schwarz ZVA40. A network analyzer will allow the user to sweep over a wide frequency range and show the exact amount of phase at a specific frequency. To start this process, the user would set up the antenna (or coil) next to the item of interest (eg turbine blade). The antenna (or coil) would then be connected to the vector network analyzer. The vector network analyzer would be setup in a sweep configuration during normal blade conditions. The user could then experiment with different damage, defects, pitting, material changes, fracture, warpage, chips or contamination to see the different amounts of phase/amplitude shift that occur in the signature at frequencies of interest. Once the ideal frequency or sweep of frequency is determined, the user could experiment with different waveforms (sine square, pulse, delta) to select the most ideal waveform to show a pronounced phase/amplitude effect. The user could also examine the amount of waveform distortion in the amplitude which may indicate a specific property change. If a dual port sensor is used the process is the same except a second antenna would be connected to the vector network analyzer and its signature would be analyzed. If a third antenna in needed, it would be connected to the third port on a vector network analyzer and its signature would be analyzed. The user could also experiment with different antenna configurations or locations to get optimal performance. The user could also correlate how the temperature of the sensed material affects the frequency of interest and the phase/amplitude change. The user could also correlate how different blade RPM's affects the frequency of interest and the phase/amplitude change. Once the experiment is complete with the vector network analyzer, a specific radio frequency phase detection circuit could be made to analyze the area of interest. The dedicated RF circuit would also have to go through additional tuning as the impedance between a network analyzer and custom circuit may differ slightly.

### Applications of This Invention

This method of RF blade and tooth analysis looks for damage, defects, pitting, material changes, fracture, warpage, chips or contamination on a metal or ceramic turbine blade, pump blade, saw blade, saw tooth, gear tooth or cutting tool. The applications include turbines, turbochargers, saws, pumps, geared equipment or cutting tools.

In a gas, steam, compressed air or compressor turbine (or turbocharger), blade health is critical. If a blade in rotating equipment were to become damaged or contaminated, the equipment could lose efficiency, become unbalanced or suffer great damage. A sensor using this method could analyze damage, defects, pitting, material changes, fracture, warpage, chips or contamination on a metal or ceramic blade. If damage were detected, the operator could be alerted to do an inspection or the equipment could be automatically shut down. This could save time and possible equipment damage.

In a pump the blade health is critical. A pump impeller blade may become clogged with debris or contamination, have damage, defects, pitting, material changes, fracture or warpage. A sensor using this method could analyze for this condition on a metal or ceramic pump impeller blade. The sensor would have to be tuned so that its signature would not be affected by the material that the pump was passing through and bubbles in that material. If damage were detected, the operator could be alerted to do an inspection or the pump could be automatically shut down. This could save time and possible equipment damage.

In a saw the blade health is critical. A saw blade may become clogged with cutting material, become dull, have damage, defects, pitting, material changes, fracture or warpage. A sensor using this method could analyze for this condition on a metal or ceramic pump impeller blade. If damage were detected, the operator could be alerted to do an inspection or the saw blade or the saw could be automatically shut down. This could save time and possible equipment damage.

In a system where there are gears, it is possible that a gear tooth may become dull, get clogged with debris, have damage, chips, defects, pitting, material changes, fracture or warpage. A sensor using this method could analyze for these conditions on a metal or ceramic pump impeller blade. If damage were detected, the operator could be alerted to do an inspection or the machinery containing the gear(s) could be automatically shut down. This could save time and possible equipment damage.

In a milling machine there are precision cutting heads that can become dull, have damage, defects, pitting, material changes, fracture, warpage, chips or contamination. A sensor using this method could analyze for this condition on a metal or ceramic cutting head. If damage were detected, the operator could be alerted to do an inspection, the tool could be automatically rejected or the milling machine would be automatically shut down. This could save time and possible equipment damage.

What is claimed is:

1. A method to analyze damage, defects, pitting, material changes, fracture, warpage, chips or contamination on an individual metal or ceramic turbine blade, pump blade, saw blade, saw tooth, gear tooth or cutting tool by observing the radio frequency change of phase/amplitude in a single port, two port or multi-port network vector circuit/instrument in the transmitted versus reflected signal of RF energy applied to an antenna(s) or coil of wire near the sample area (eg turbine blade) utilizing a position sensor with optional temperature sensor to build a signature of the individual blade tooth phase/amplitude with respect to blade/tooth position with applications including turbines, turbochargers, saws, pumps, geared equipment or cutting tools.

2. An optimized radio frequency network vector [change of phase] circuit utilizing an integrated circuit like the 74HCT9046 [or similar integrated circuit] that detects the phase change in the transmitted energy versus the reflected energy in a two port or three port antenna near the sample area (eg turbine blade) to analyze for damage, defects, pitting, material changes, fracture, warpage, chips or contamination on a metal or ceramic turbine blade, pump blade, saw blade, saw tooth, gear tooth or cutting tool that includes a controller (microprocessor, microcontroller, DSP, ASIC or FPGA) and blade/tooth position sensor with optional temperature sensor that would build a signature of the individual blade tooth phase/amplitude with respect to blade/tooth position.

3. A method that builds an horizontal and vertical X-Y signature utilizing a blade or tooth position sensor in combination with RF amplitude and or phase change circuit/instrument in a single port, two port or multi-port network vector in the transmitted versus reflected signal of RF energy applied to an antenna(s) or coil of wire near the sample area (eg turbine blade) to analyze damage, defects, pitting, material changes, fracture, warpage, chips or contamination on a metal or ceramic turbine blade, pump blade, saw blade, saw tooth, gear tooth or cutting tool and this signature may have out of range boundaries applied to determine the blade or tooth properties that can be adjusted depending on temperature and RPM which may be individually applied to each tooth or blade that is being observed.
